(19) United States
(12) Patent Application Publication
(10) Pub. No.: US 2008/0080091 A1
(43) Pub. Date: Apr. 3, 2008

(54) Magnetic head and method of producing the same

(75) Inventor: Masanori Akie, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/653,017

(22) Filed: Jan. 10, 2007

(30) Foreign Application Priority Data
Sep. 28, 2006 (JP) 2006-263733

(51) Int. Cl. G11B 5/127

(52) U.S. Cl. 360/110

(57) ABSTRACT

The magnetic head is capable of controlling characteristics of hard films close to a read-element so as to suitably apply bias magnetic fields of the hard films to the read-element. The magnetic head basically comprises: a read-element; a lower shielding layer; insulating films respectively coating side faces of the read-element and a surface of the lower shielding layer; and hard films being respectively formed on the insulating films with base layers. The magnetic head is characterized in that each of the base layers is constituted by: a first base layer coating a first part of the insulating film, which coats the side face of the read-element; and a second base layer coating a second part of the insulating film, which coats a part of the lower shielding layer outwardly extending from the side face of the read-element.

### BACKGROUND OF THE INVENTION

The present invention relates to a magnetic head and a method of producing the magnetic head, more precisely relates to a magnetic head, which includes a CPP (current perpendicular to the plane) type read-head and is characterized by arrangement of hard films, and a method of producing the magnetic head.

FIG. 8 is a sectional view of a conventional magnetic head, which includes a CPP type read-head, seen from an air bearing surface side. In the CPP type read-head, a sensing current runs in a thickness direction (a film layering direction) of the read-element 10 so as to read magnetic data. Therefore, side faces of the read-element 10 and a surface of a lower shielding layer 18, on which the read-element 10 is formed, are coated with insulating films 12.

Hard films 14 are provided on the both sides of the read-element 10. The hard films 14 apply magnetic fields to a free layer of the read-element 10 so as to stabilize a magnetic domain of the free layer. The hard films 14 are made of a magnetic material having a large coercive force, e.g., CoCrPt, CoPt.

Base layers 16 are respectively formed on the insulating films 12, and the hard films 14 are respectively formed on the base layers 16 by sputtering. The hard films 14 are magnetized in the horizontal direction, which is parallel to a plane direction of the free layer of the read-element 10. The base layers 16 crystal-grow the hard films 14 and orient their crystal orientations in prescribed directions so as to magnetize the hard films 14 in the horizontal direction. Namely, the base layers 16 controls the orientation directions of the hard films 14 so as to align the magnetizing directions in a plane direction of the base layers 16. The base layers 16 are made of, for example, Cr, CrTi, etc. The conventional magnetic head is disclosed in, for example, Japanese Patent Gazette No. 2005-38508.

The read-element 10 is made thinner so as to read data recorded on a recording medium with high recording density. Thus, side faces of the read-element 10 are inclined nearly 90 degrees with respect to an end face seen from the air bearing surface includes. By inclining the side faces of the read-element 10 nearly 90 degrees, parts of the insulating films 12, which coat the side faces of the read-element 10, precipitously rise with respect to parts of the insulating films 12, which coat the surface of the lower shielding layer 18. Therefore, parts of the base layers 16, which coat the insulating films 12 and correspond to the side faces of the read-element 10, also rise.

By precipitously rising the parts of the base layers 16 corresponding to the side faces of the read-element 10, the magnetizing directions of parts of the hard films 14 distant from the side faces of the read-element 10 are oriented in the horizontal directions; the magnetizing directions of parts of the hard films 14 corresponding to the side faces of the read-element 10 are oriented in the near-vertical directions (see arrows in FIG. 8). The reason is that the base layers 16 crystal-grow the hard films 14 so as to magnetize the hard films 14 in the direction parallel to the plane direction of the base layers 16. Deviation of the magnetizing directions of the parts of the hard films 14 corresponding to the side faces of the read element 10 with respect to the horizontal direction are increased when the inclination angles of the side faces of the read-element 10 approach 90 degrees.

The hard films 14 apply horizontal magnetic fields to the free layer of the read-element 10. Therefore, if the magnetizing directions of the hard films 14 are deviated from the horizontal direction, control of the magnetic domain of the free layer of the read-element 10, which is performed by bias magnetic fields of the hard films 14, is disturbed, so that stability of the read-element is also disturbed. Especially, the parts of the hard films 14 corresponding to the side faces of the read-element 10 are the closest parts to the read-element 10. Therefore, if the magnetizing directions of those parts of the hard films 14 are deviated from the horizontal direction, characteristics of the read-head must be badly influenced.

### SUMMARY OF THE INVENTION

The present invention was conceived to solve the above described problems.

An object of the present invention is to provide a magnetic head including a CPP type read-head, which is capable of controlling characteristics of hard films close to a read-element so as to suitably apply bias magnetic fields of the hard films to the read-element.

Another object is to provide a method of producing said magnetic head.

To achieve the objects, the present invention has following structures.

Namely, a first basic structure of the magnetic head of the present invention comprises: a read-element; a lower shielding layer; insulating films respectively coating side faces of the read-element and a surface of the lower shielding layer; and hard films being respectively formed on the insulating films with base layers, and is characterized in that each of the base layers is constituted by: a first base layer coating a first part of the insulating film, which coats the side face of the read-element; and a second base layer coating a second part of the insulating film, which coats a part of the lower shielding layer outwardly extending from the side face of the read-element.

A second basic structure of the magnetic head of the present invention comprises: a read-element; a lower shielding layer; insulating films respectively coating side faces of the read-element and a surface of the lower shielding layer; and hard films being respectively formed on the insulating films with base layers, and is characterized in that each of the base layers is constituted by: a first base layer coating a surface of the insulating film; and a second base layer coating a part of the first base layer, which correspond to a part of the lower shielding layer outwardly extending from the side face of the read-element.

Note that, the first base layers and the second base layers are made of different materials having different characteristics, e.g., orientation direction of the hard film, density of the hard film, as the base layers for forming the hard films.

In each of the magnetic heads, the first base layer may be made of a material, which crystal-grows the first base layer and makes a magnetizing direction of the hard film perpendicular to the surface of the first base layer, and the second base layer may be made of a material, which crystal-grows the second base layer and makes a magnetizing direction of the hard film parallel to the surface of the second base layer. With this structure, bias magnetic fields of the hard films can be suitably applied to the read-element.

Next, a first method of producing a magnetic head, which comprises: a read-element; a lower shielding layer on which the read-element is formed; insulating films respectively coating side faces of the read-element and a surface of the lower shielding layer; and hard films being respectively formed on the insulating films with base layers, comprises the steps of: forming first base layers on the side faces of the read-element and surfaces of the insulating films, which coat parts of the lower shielding layer outwardly extending from the side faces of the read-element; shielding parts of the first base layers, which respectively coat the side faces of the read-element, with a mask pattern for forming the read-element; removing parts of the first base layers, which respectively coat parts of the insulating films outwardly extending from the side faces of the read-element; forming second base layers on the parts of the insulating films outwardly extending from the side faces of the read-element with the mask pattern; and forming the hard films on the both sides of the read-element, and the first base layers and the second layers are used as the base layers.

A second method of producing a magnetic head, which comprises: a read-element; a lower shielding layer on which the read-element is formed; insulating films respectively coating side faces of the read-element and a surface of the lower shielding layer; and hard films being respectively formed on the insulating films with base layers, comprises the steps of: forming first base layers on the side faces of the read-element and surfaces of the insulating films, which coat parts of the lower shielding layer outwardly extending from the side faces of the read-element; shielding parts of the first base layers, which respectively coat the side faces of the read-element, with a mask pattern for forming the read-element; forming second base layers on the parts of the insulating films outwardly extending from the side faces of the read-element with the mask pattern; and forming the hard films on the both sides of the read-element, and the first base layers and the second layers are used as the base layers.

In each of the methods, the first base layer may be made of a material, which crystal-grows the first base layer and makes a magnetizing direction of the hard film perpendicular to the surface of the first base layer, and the second base layer may be made of a material, which crystal-grows the second base layer and makes a magnetizing direction of the hard film parallel to the surface of the second base layer. With this method, bias magnetic fields of the hard films can be suitably applied to the read-element.

In each of the methods, a lower layer may be made thinner than an upper layer when the mask pattern is formed. With this method, the second base layers can be easily formed on the parts of the insulating films extended from the side faces of the read-element.

In the magnetic head of the present invention, each of the base layers is constituted by the first base layer corresponding to the side face of the read-element and the second base layer corresponding to the part of the lower shielding layer outwardly extending from the side face thereof, and the first base layer and the second base layer are made of different materials. Characteristics of each of the hard films, e.g., orientation directions, can be controlled in the part corresponding to the side face of the read-element and the part corresponding to the part of the lower shielding layer outwardly extending from the side face thereof respectively.

By employing the method of the present invention, even if inclination angles of the side faces of the side faces are about 90 degrees, the magnetizing directions of the hard films can be wholly correct to the direction parallel to a free layer of the read-element, so that the bias magnetic fields can be suitably applied to the read-element, characteristics of the read-head can be improved and a high density recording medium can be suitably used.

### BRIEF DESCRIPTION OF THE DRAWINGS

Embodiments of the present invention will now be described by way of examples and with reference to the accompanying drawings, in which:

FIG. 1 is a sectional view of a magnetic head of a first embodiment of the present invention;

FIGS. 2A-2E are explanation views showing production steps of the magnetic head of the first embodiment;

FIGS. 3A-3D are explanation views showing further production steps of the magnetic head of the first embodiment;

FIG. 4 is a sectional view of a magnetic head of a second embodiment;

FIGS. 5A-5D are explanation views showing production steps of the magnetic head of the second embodiment;

FIG. 6 is a plan view of a magnetic disk drive unit;

FIG. 7 is a perspective view of a head slider; and

FIG. 8 is a sectional view of the conventional magnetic head.

### DETAILED DESCRIPTION OF THE EMBODIMENTS

Preferred embodiments of the present invention will now be described in detail with reference to the accompanying drawings.

### First Embodiment

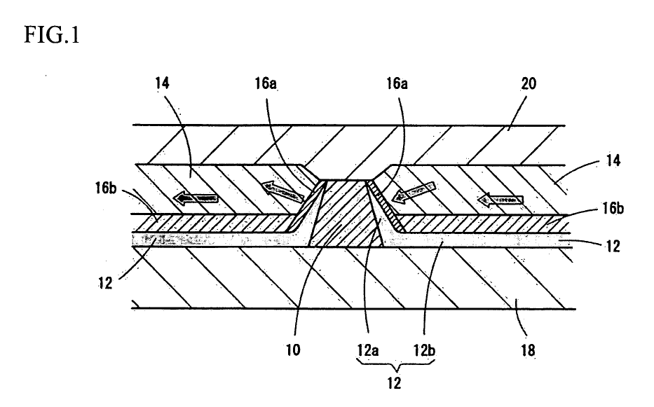

FIG. 1 is a sectional view of a read-head of a magnetic head of a first embodiment seen from an air bearing surface side. The basic structure of the read-head is the same as that of the conventional read-head shown in FIG. 8. Namely, a lower shielding layer 8 and an upper shielding layer 20 sandwich the read-element 10 in the thickness direction. Side faces of the read-element 10 and parts of the lower shielding layer 18, which outwardly extend from the read-element 10, are respectively coated with insulating films 12. Hard films 14 are respectively provided on the both sides of the read-element 10. The hard films 14 apply bias magnetic fields to a free layer of the read-element 10 so as to make the free layer have a single domain structure.

The read-head of the present embodiment is characterized by base layers, which are used for forming the hard magnetic layers 14 and which are formed on the insulating films 12. Namely, first base layers 16a are respectively formed on first parts 12a of the insulating films 12, which respectively coat side faces of the read-element 10; second base layers 16b are respectively formed on second parts 12b of the insulating films 12, which outwardly extend from the first parts 12a. The first base layers 16a and the second base layers 16b are made of different materials.

The first base layers 16a are formed to crystal-grow the hard films 14 and orient magnetizing directions of the hard films 14 perpendicular to plane directions of the first base layers 16a; the second base layers 16b are formed to crystal-grow the hard films 14 and orient magnetizing directions of the hard films 14 parallel to plane directions of the second base layers 16b. In the present embodiment, orientation characteristics of the second base layers 16b are the same as that of the base layer 16 of the conventional read-head (see FIG. 8). The second base layers 16b are made of, for example, Cr, CrTi. On the other hand, the first base layers 16a orient the magnetizing directions of the hard films 14 perpendicular to the plane directions thereof, so they are made of, for example, Ru.

In the present embodiment, the first base layer 16a and the second base layer 16b are formed on each of the insulating films 12. The first base layer 16a is formed on the first part 12a, which coats the side face of the read-element 10, so as to orient the magnetizing direction of the hard film 14 perpendicular to the plane direction of the first base layer 16a; the second base layer 16b is formed on the second part 12b, which coats the part of the lower shielding layer 18 outwardly extending from the read-element 10, so as to orient the magnetizing direction of the hard film 14 parallel to the plane direction of the second base layer 16b. With this structure, the hard films 14 are wholly magnetized in the horizontal directions, as shown by arrows in FIG. 1, when the hard films 14 are magnetized.

In parts of the hard films 14, which correspond to the parts of the lower shielding layer 18 outwardly extending from the read-element 10, the magnetizing directions are parallel to the plane directions of the second base layers 16b and the read-element 10 (a plane direction of the free layer of the read-element 10). On the other hand, in parts of the hard films 14, which correspond to the side faces of the read-element 10, the magnetizing directions are perpendicular to the plane directions of the first base layers 16a and orientated in the horizontal direction. Since the side faces of the read-element 10 are slightly inclined with respect to a direction perpendicular to the surface of the lower shielding layer 18, the magnetizing directions of the parts of the hard films 14, which correspond to the side faces of the read-element 10, cannot be oriented in the perfect horizontal direction. However, the magnetizing directions of said parts of the hard films 14 can be oriented close to the horizontal direction by approximating the inclination angles of the side faces of the read-element 10 to 90 degrees.

In comparison with directions of the arrows shown in FIG. 1, which indicate the magnetizing directions of the hard films 14 (directions of bias magnetic fields) and directions of the arrows shown in FIG. 8, which indicate the magnetizing directions of the hard films 14 (directions of bias magnetic fields), the hard films 14 of the present embodiment are wholly magnetized in the horizontal direction and the bias magnetic fields are suitably applied to the read-element 10.

As described above, in the present embodiment, the magnetizing directions of the hard films 14 can be wholly oriented in the horizontal direction, and the bias magnetic fields can be horizontally applied to the read-element 10. Therefore, stability of the magnetic head and a function of reading magnetic data recorded in a magnetic recording medium can be improved. By horizontally orientating the magnetic directions of the parts of the hard films 14, which are the closest parts to the read-element 10, characteristics of the read-element 10 can be effectively improved.

### (Method of Producing the Magnetic Head)

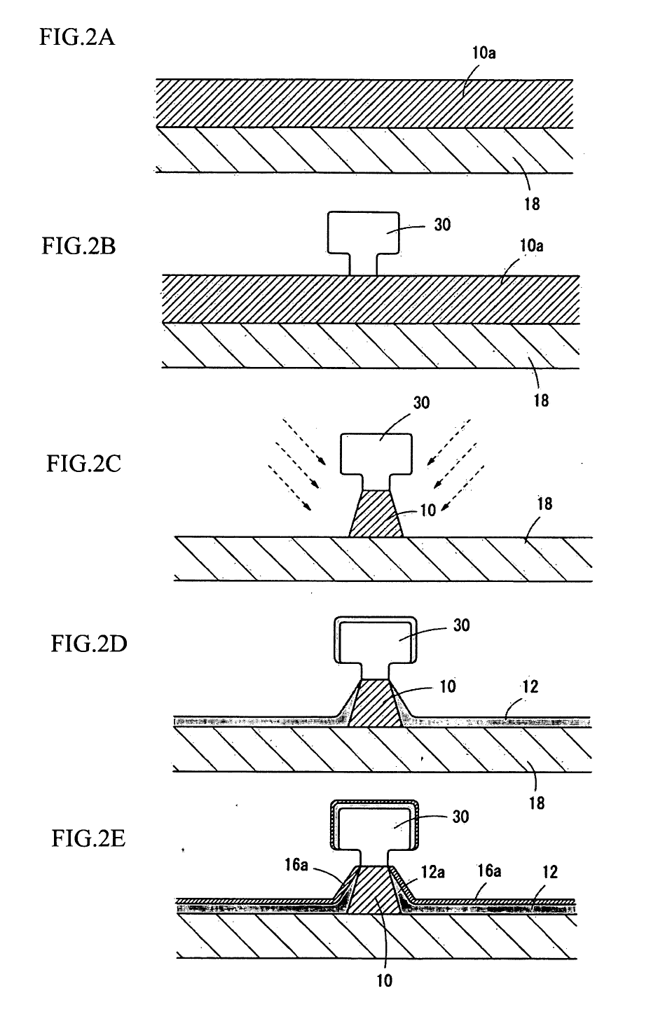

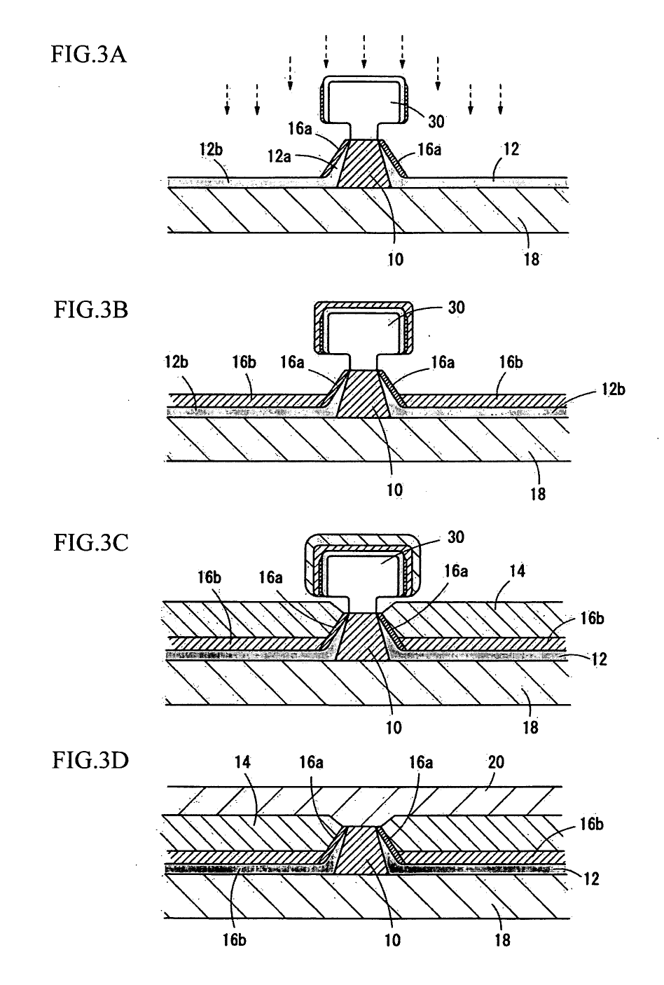

A method of producing the read-head of the magnetic head of the first embodiment will be explained with reference to FIGS. 2A-2E and FIGS. 3A-3D.

In FIG. 2A, the lower shielding layer 18 is formed on an ALTIC board, then a magnetoresistance effect film 10a, which will become the read-element 10, is formed on an entire surface of the lower shielding layer 18. The lower magnetic shielding layer 18 is made of a soft magnetic material, e.g., NiFe.

The magnetic resistance effect film 10a includes a pinned layer, whose magnetizing direction is fixed, and a free layer, whose magnetizing direction is varied by a magnetic field from a magnetic recording medium. The magnetoresistance effect film 10a further includes ferromagnetic layers, which constitute the pinned layer and the free layer, an antiferromagnetic layer for fixing the magnetizing direction of the pinned layer, and nonmagnetic layers. The layered structures are designed on the basis of products. Note that, the present invention is not limited to the magnetoresistance resistance effect film 10a having said structure.

In FIG. 2B, photo resist is applied on the surface of the magnetoresistance effect film 10a, and the photo resist is patterned to form a mask pattern 30, which covers a part to be formed into the read-element 10. The two-layered resist, whose etching rates are different in the layers, is used. After etching the resist, a lower part of the mask pattern 30 is made thinner than an upper part thereof.

In FIG. 2C, the magnetoresistance effect film 10a is etched by ion-milled, and the read-element 10, whose sectional shape is like a trapezoid, is formed. Preferably, a work piece is diagonally ion-milled so as to approximate the inclination angles of the side faces to 90 degrees.

In FIG. 2D, the side faces of the read-element 10 and a surface of the lower shielding layer 18 are coated with the insulating films 12. The insulating films 12 are formed by, for example, sputtering alumina.

In FIG. 2E, the first base layers 16a are respectively formed on the insulating films 12. The first base layers 16a are formed by, for example, sputtering Ru. In this step, the surface of the work piece is diagonally sputtered so as to stick the first base layers 16a onto surfaces of the first parts 12a of the insulating films 12, which coat the side faces of the read-element 10. By the sputtering process, the first base layers 16a stick onto surfaces of the insulating films 12, which coat the surface of the lower shielding layer 18, too.

In FIG. 3A, the work piece is ion-milled so as to leave the first base layers 16a on only the first parts 12a of the insulating films 12, which coat the side faces of the read-element 10. By vertically ion-milling the surface of the work piece, the first base layers 16a are left on the side faces of the read-element 10 due to the mask pattern 30, which shields the side parts of the read-element 10, so that the first base layers 16a are left on the side faces. On the other hand, the first base layers 16a formed on the surfaces of the parts of the lower shielding layer 18, which outwardly extend from the side faces of the read-element 10, are removed.

In FIG. 3B, the second base layers 16b are respectively formed on the surfaces of the parts of the lower shielding layer 18, which outwardly extend from the side faces of the read-element 10, by sputtering. Since the first base layers 16a on the side faces of the read-element 10 are shielded by the mask pattern 30, the second base layers 16b are formed on the second parts 12b of the insulating films 12, which outwardly extend from the first parts 12a, by vertically sputtering onto the surface of the work piece.

In FIG. 3C, the hard films 14 are formed. The first base layer 16a and the second base layer 16b, which are formed on each of the insulating films 12, are used as the base layer for forming each of the hard films 14. The hard films 14 are made of a ferromagnetic material having a large coercive force, e.g., CoCrPt, CoPt.

In FIG. 3D, the mask pattern 30 is removed, and the upper shielding layer 20 is formed. The upper shielding layer 20 is also made of a soft magnetic material, e.g., NiFe.

By the above described steps, the read-head shown in FIG. 1 can be produced. As described above, the parts of the hard films 14, which correspond to the side faces of the read-element 10, are formed on the first base layers 16a; the parts of the hard films 14, which correspond to the parts of the lower shielding layer 18 outwardly extending from the side faces of the read-element 10, are formed on the second base layers 16b.

### Second Embodiment

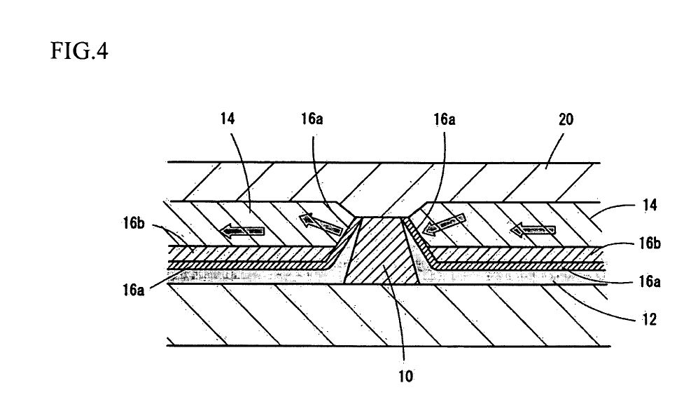

FIG. 4 is a sectional view of a magnetic head of a second embodiment. Note that, the elements described in the first embodiments are assigned the same symbols and explanation will be omitted.

In the magnetic head of the present embodiment, the first base layers 16a correspond to the side faces of the read-element 10, and the second base layers 16b correspond to the parts of the lower shielding layer 18 outwardly extending from the side faces of the read-element 10, as well as the first embodiment. Unlike the first embodiment, the magnetic head of the present embodiment is characterized in that the second base layers 16b are respectively formed on the first base layers 16a outwardly extending until covering the lower shielding layer 18. Namely, the first base layer 16a and the second base layer 16b are layered in an area distant from the side face of the read-element 10.

The first base layers 16a are formed to crystal-grow the hard films 14 and orient magnetizing directions of the hard films 14 perpendicular to plane directions of the first base layers 16a; the second base layers 16b are formed to crystal-grow the hard films 14 and orient magnetizing directions of the hard films 14 parallel to plane directions of the second base layers 16b.

Therefore, in the second embodiment too, the magnetizing directions of the parts of the hard films 14, which are grown on the second base layers 16b, are made parallel to the horizontal direction (a plane direction of the free layer of the read-element 10); the magnetizing directions of the parts of the hard films 14, which are grown on the first base layers 16a, are vertically oriented. Therefore, the magnetizing directions of the hard films 14 in the vicinity of the side faces of the read-element 10 are oriented in the horizontal direction (see FIG. 4).

As shown by arrows in FIG. 4, the magnetizing directions of the hard films 14 are wholly oriented in the horizontal direction, bias magnetic fields can be horizontally applied to the read-element 10. Therefore, stability of the magnetic head can be improved, and the magnetic head is capable of recording data with high density.

### (Method of Producing the Magnetic Head)

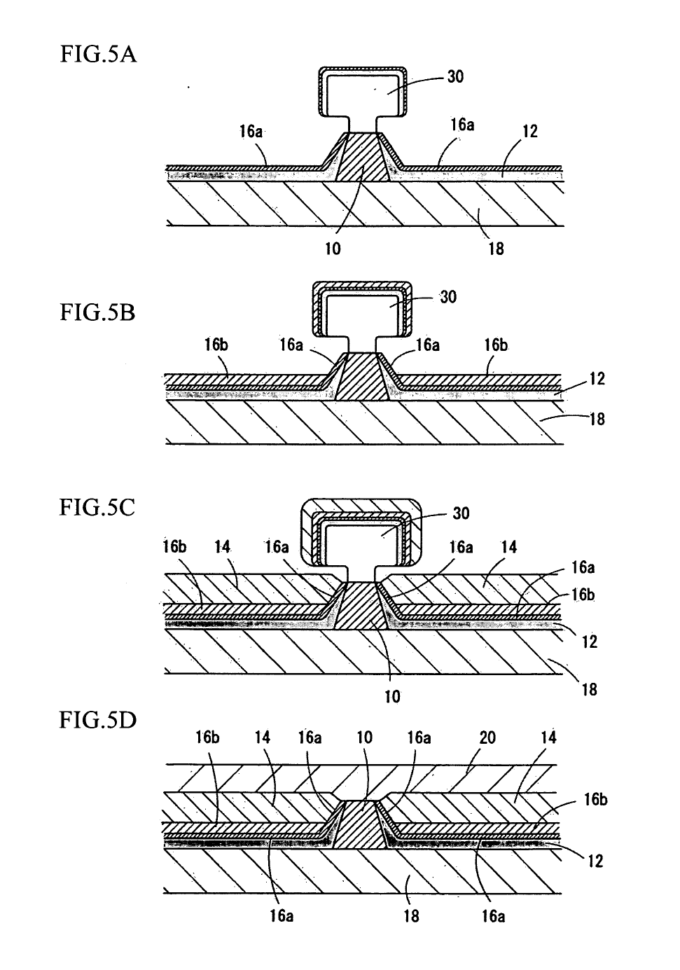

A method of producing the read-head of the magnetic head of the second embodiment will be explained with reference to FIGS. 5A-5D.

In FIG. 5A, the read-element 10 is formed on the lower shielding layer 18, the insulating films 12 are formed thereon, and then the first base layers 16b are respectively formed on the insulating films 12. The process until forming the first base layers 16a is the same as that of the first embodiment. Namely, FIG. 5A corresponds to FIG. 2E.

In FIG. 5B, the second base layers 16b are formed on the first base layers 16a by sputtering. The second base layers 16b are made of a material which makes the magnetizing directions of the hard films 14 parallel to the planes of the second base layers 16b, e.g., Cr, CrTi. Since the first base layers 16a on the side faces of the read-element 10 are shielded by the mask pattern 30, the second base layers 16b are formed on the parts of the first base layers 16a, which outwardly extend parallel to the lower shielding layer 18, by vertically sputtering onto the surface of the work piece.

In FIG. 5C, the hard films 14 are formed on the first base layers 16a and the second base layers 16b by sputtering. The hard films 14 are made of a ferromagnetic material having a large coercive force, e.g., CoCrPt, CoPt. The hard films 14 are slightly thicker than the read-element 10.

In FIG. 5D, the mask pattern 30 is removed, and then the upper shielding layer 20 is formed by sputtering.

By the above described steps, the magnetic head of the present embodiment shown in FIG. 4 can be produced.

### (Magnetic Disk Drive Unit)

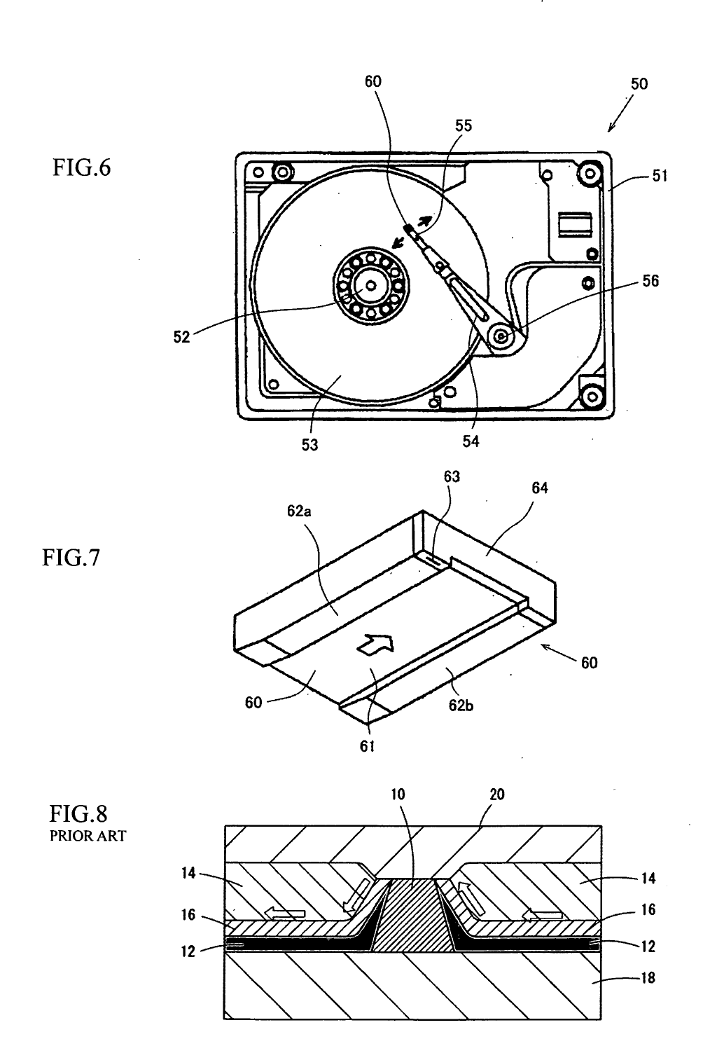

A magnetic disk drive unit having the magnetic head of the present invention is shown in FIG. 6. The magnetic disk drive unit 50 comprises: a rectangular box-shaped casing 51; a spindle motor 52 accommodated in the casing 51; and a plurality of magnetic recording disks 53 rotated by the spindle motor 52. Carriage arms 54, which can be swung in planes parallel to the surfaces of the disks 53, are located beside the disks 53. A head suspension 55 is attached to a longitudinal front end of each of the carriage arms 54. A head slider 60 is attached to a front end of the head suspension 55. The head slider 60 is attached to a disk side face of the head suspension 55.

FIG. 7 is a perspective view of the head slider 60. In an air bearing surface of the head slider 60 which faces the surface of the disk 53, floating rails 62a and 62b for floating the head slider 60 from the surface of the disk 53 are formed along side edges of a slider body 61. A magnetic head 63 having the above described read-head is provided to the front end side (the air-outflow side) of the head slider 60 so as to face the disk 53. The magnetic head 63 is coated and protected by a protection film 64.

When the magnetic disks 53 are rotated by the spindle motor 52, each of the head sliders 60 is floated from the surface of the disk 53 by air stream generated by the rotation of the disk 53, and then a seek action is performed by an actuator 56 so that data are written in and read from the disk 53 by the magnetic head 63.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head,
comprising:
a read-element;
a lower shielding layer;
insulating films respectively coating side faces of said read-element and a surface of said lower shielding layer; and
hard films being respectively formed on said insulating films with base layers,
wherein each of said base layers is constituted by:
a first base layer coating a first part of said insulating film, which coats the side face of said read-element; and
a second base layer coating a second part of said insulating film, which coats a part of said lower shielding layer outwardly extending from the side face of said read-element.

2. A magnetic head,
comprising:
a read-element;
a lower shielding layer;
insulating films respectively coating side faces of said read-element and a surface of said lower shielding layer; and
hard films being respectively formed on said insulating films with base layers,
wherein each of said base layers is constituted by:
a first base layer coating a surface of said insulating film; and
a second base layer coating a part of said first base layer, which correspond to a part of said lower shielding layer outwardly extending from the side face of said read-element.

3. The magnetic head according to claim 1,
wherein said first base layer is made of a material, which crystal-grows said first base layer and makes a magnetizing direction of said hard film perpendicular to the surface of said first base layer, and
said second base layer is made of a material, which crystal-grows said second base layer and makes a magnetizing direction of said hard film parallel to the surface of said second base layer.

4. The magnetic head according to claim 2,
wherein said first base layer is made of a material, which crystal-grows said first base layer and makes a magnetizing direction of said hard film perpendicular to the surface of said first base layer, and
said second base layer is made of a material, which crystal-grows said second base layer and makes a magnetizing direction of said hard film parallel to the surface of said second base layer.

5. A method of producing a magnetic head, which comprises: a read-element; a lower shielding layer on which said read-element is formed;
insulating films respectively coating side faces of said read-element and a surface of said lower shielding layer; and hard films being respectively formed on said insulating films with base layers, comprising the steps of:
forming first base layers on the side faces of said read-element and surfaces of said insulating films, which coat parts of said lower shielding layer outwardly extending from the side faces of said read-element;
shielding parts of said first base layers, which respectively coat the side faces of said read-element, with a mask pattern for forming said read-element;
removing parts of said first base layers, which respectively coat parts of said insulating films outwardly extending from the side faces of said read-element;
forming second base layers on the parts of said insulating films outwardly extending from the side faces of said read-element with said mask pattern; and
forming said hard films on the both sides of said read-element, wherein said first base layers and said second layers are used as said base layers.

6. A method of producing a magnetic head, which comprises: a read-element; a lower shielding layer on which said read-element is formed; insulating films respectively coating side faces of said read-element and a surface of said lower shielding layer; and hard films being respectively formed on said insulating films with base layers, comprising the steps of:
forming first base layers on the side faces of said read-element and surfaces of said insulating films, which coat parts of said lower shielding layer outwardly extending from the side faces of said read-element;
shielding parts of said first base layers, which respectively coat the side faces of said read-element, with a mask pattern for forming said read-element;
forming second base layers on the parts of said insulating films outwardly extending from the side faces of said read-element with said mask pattern; and
forming said hard films on the both sides of said read-element, wherein said first base layers and said second layers are used as said base layers.

7. The method according to claim 5,
wherein said first base layer is made of a material, which crystal-grows said first base layer and makes a magnetizing direction of said hard film perpendicular to the surface of said first base layer, and
said second base layer is made of a material, which crystal-grows said second base layer and makes a magnetizing direction of said hard film parallel to the surface of said second base layer.

8. The method according to claim 6,
wherein said first base layer is made of a material, which crystal-grows said first base layer and makes a magnetizing direction of said hard film perpendicular to the surface of said first base layer, and
said second base layer is made of a material, which crystal-grows said second base layer and makes a magnetizing direction of said hard film parallel to the surface of said second base layer.

9. The method according to claim 5,
wherein a lower layer is made thinner than an upper layer when said mask pattern is formed.

10. The method according to claim 6,
wherein a lower layer is made thinner than an upper layer when said mask pattern is formed.
